(19) United States
(12) Patent Application Publication
(10) Pub. No.: US 2014/0069252 A1
(43) Pub. Date: Mar. 13, 2014

(54) GROOVING METHOD, GROOVING TOOL, AND GROOVING TOOL HOLDING STRUCTURES

(71) Applicant: OKUMA CORPORATION, Niwa-Gun (JP)

(72) Inventor: Dai HARITANI, Niwa-Gun (JP)

(73) Assignee: OKUMA CORPORATION, Niwa-Gun (JP)

(21) Appl. No.: 13/857,387

(22) Filed: Apr. 5, 2013

(30) Foreign Application Priority Data
Sep. 12, 2012 (JP) 2012-200689

(51) Int. Cl. B26D 3/06

(52) U.S. Cl. CPC B26D 3/06
USPC 83/875; 83/698.11

(57) ABSTRACT

A plurality of cutting blades is linearly arranged on the right and left sides of a plate that is placed vertically. The cutting blades on one side are arranged so as to face downward, and the cutting blades on the other side are arranged so as to face upward. With a tool thus formed, a cutting operation is performed by making a circular motion in a plane in which the cutting blades are formed, and the cutting operation using the circular motion is repeated with the tool shifted by a predetermined pitch in a cutting direction. The tool is tilted in the cutting plane when subjected to high stress.

### BACKGROUND OF THE INVENTION

The disclosure of Japanese Patent Application No. 2012-200689 filed on Sep. 12, 2012, including the specification, drawings and abstract is incorporated herein by reference in its entirety.

### TECHNICAL FIELD

The present invention relates to grooving methods of performing a grooving process, grooving tools, and grooving tool holding structures that mount the grooving tool on a machine tool.

### BACKGROUND ART

One method of performing a so-called slitting process to form a narrow groove is to use a tool having a saw blade shape. For example, Japanese Patent Application Publication No. 2004-322239 (JP 2004-322239 A) uses a broach (grooving tool) having a blade provided along the entire length of a broach body like a saw, and the broach is inserted into a processing hole to cut a keyway by sliding operation.

However, especially when performing deep grooving in the slitting process, load that is applied to the grooving tool is increased, which can cause damage to the tool or early wear of the tool.

In the case of using a saw-like tool as in JP 2004-322239 A, chippings tend to accumulate between cutting blades, which causes deterioration of the processing surface.

### SUMMARY OF THE INVENTION

The present invention was developed in view of the above problems, and it is an object of the present invention to provide a grooving method, a grooving tool, and a grooving tool holding structure, in which chippings are less likely to accumulate between cutting blades during a process, and which can reduce load that is applied to the tool.

In order to solve the above problems, according to a first aspect of the present invention, a grooving method includes: cutting a workpiece by causing a tool to make a circular motion or an arc motion. In the grooving method, the tool includes a cutting blade group which is comprised of a plurality of cutting blades arranged linearly and whose cutting direction is a direction in which the plurality of cutting blades is arranged, and the circular motion or the arc motion is made in a plane in which the cutting blades are arranged.

According to this method, the tool is caused to make the circular motion or the arc motion. Accordingly, a single cutting operation is not continuously performed, and chippings are less likely to accumulate between the cutting blades. This can reduce load that is applied to the tool, and allows smooth processing to be maintained. Since the cutting operation does not involve any linear motion and is performed by using the circular motion or the arc motion, a smooth processing operation can be achieved, and chippings can be dropped after every processing cycle.

According to a second aspect of the present invention, in the method according to the first aspect, after the cutting operation using the circular motion or the arc motion is performed, the cutting operation using the circular motion or the arc motion may be repeated with the tool shifted by a predetermined pitch in the cutting direction.

According to this method, since the processing is performed with the tool shifted by the predetermined pitch, a grooving process that does not cut only a specific part and thus forms a uniform cut surface can be implemented.

According to a third aspect of the present invention, in the method according to the first or second aspect, the tool may have the cutting blade group on both right and left sides of a plate that is placed vertically, and the cutting blade groups on both sides of the plate may be arranged so as to be parallel to each other and so as to have opposite cutting directions to each other. After being cut downward with the downward-facing cutting blade group, the workpiece may be cut upward with the upward-facing cutting blade group, and right and left side portions of a groove may be cut by one reciprocating movement of the tool using the circular motion.

With this configuration, it is not necessary to change the direction of the tool to process the opposite side surface of the groove, and both ends of the groove can be processed by one reciprocating movement of the tool, whereby processing time can be reduced.

According to a fourth aspect of the present invention, a grooving tool which is mounted on a machine tool including a mechanism that moves along at least two perpendicular axes, and which performs a grooving process on a workpiece. The grooving tool includes: a cutting blade group which is comprised of a plurality of cutting blades arranged linearly and whose cutting direction is a direction in which the plurality of cutting blades is arranged. In the grooving tool, the cutting blade group is placed on both right and left sides of a plate that is placed vertically, and the cutting blade groups on both sides of the plate are arranged so as to be parallel to each other and so as to have opposite cutting directions to each other.

With this configuration, since the cutting blades are provided on both sides of the plate, it is not necessary to change the tool to process the opposite side surface of the groove, and processing time can be reduced.

Moreover, the cutting operation can be performed by both downward and upward movements of the tool that is placed vertically, and both sides of the groove can be processed by the arc motion or the circular motion of the tool, whereby processing time can be reduced.

According to a fifth aspect of the present invention, in the configuration according to the fourth aspect, of the cutting blade groups placed on both sides of the plate so as to be parallel to each other, the cutting blade located at a tip end may be placed so as to protrude beyond the remainder of the cutting blades by a predetermined amount.

With this configuration, since finish processing can be performed by using the protruding cutting blade located at the tip end, it is not necessary to change the tool to perform the finish processing, and processing efficiency is improved.

According to a sixth aspect of the present invention, a grooving tool holding structure includes: a tool holder in which a block having attached thereto a grooving tool having a plurality of cutting blades arranged linearly is held by a base. In the grooving tool holder structure, the grooving tool holding structure holds the tool holder on a tool base of a machine tool including a mechanism that moves along at least two perpendicular axes, and the block is pivotally attached to and held by the base, and the block held by the base is capable of swinging in a plane parallel to a plane in which the cutting blades are arranged.

With this configuration, the angle of the tool can be changed. Accordingly, when stress that is applied to the tool increases during the grooving process, the angle of the tool is changed so that the tool can avoid being subjected to the stress. Thus, damage to the tool can be prevented.

According to a seventh aspect of the present invention, in the configuration according to the sixth aspect, the base may have a limiting unit that limits a swing width of the block, and an elastic biasing unit that biases the block in a direction in which swinging is restrained, the elastic biasing unit may be formed in a pair so as to press from right and left the block that swings in a swing plane, and the block may be biased by the elastic biasing unit and held in a stable state at a prescribed angle, and may be tilted within a swing range when subjected to an external force exceeding certain stress.

With this configuration, the tool is not tilted unless it is subjected to excessive stress. Thus, accurate processing can be implemented.

According to the grooving method of the present invention, the tool is caused to make the circular motion or the arc motion to perform the cutting operation. Accordingly, a single cutting operation is not continuously performed, and chippings are less likely to accumulate between the cutting blades. This can reduce load that is applied to the tool, and allows smooth processing to be maintained. Since the cutting operation does not involve any linear motion and is performed by using the circular motion or the arc motion, a smooth processing operation can be achieved, and chippings can be dropped after every processing cycle.

According to the grooving tool of the present invention, it is not necessary to change the direction of the tool to process the opposite side of the groove, and both ends of the groove can be processed by the reciprocating movement of the tool, whereby processing time can be reduced.

According to the grooving tool holding structure of the present invention, the angle of the tool can be changed. Accordingly, when stress that is applied to the tool increases during the processing, the angle of the tool is changed so that the tool can avoid being subjected to the stress. Thus, damage to the tool can be prevented.

### BRIEF DESCRIPTION OF THE DRAWINGS

FIGS. 1A to 1C are illustrations showing an example of a grooving tool according to the present invention, where FIG. 1A is a front view, FIG. 1B is a vertical section taken along line A-A in FIG. 1A, and FIG. 1C is a sectional view taken along line B-B in FIG. A.

FIG. 2 is an enlarged view of a portion C in FIG. 1C.

FIG. 3 is an enlarged view of the tip end of the tool.

FIG. 4 is an illustration of processing procedures, illustrating a front view at the time of approach of a grooving process.

FIG. 5 is an illustration of preprocessing of the grooving process in FIG. 4.

FIG. 6 is an enlarged illustration of a processing portion.

FIG. 7 is an illustration showing a processing flow.

FIG. 8 is another illustration showing a processing flow.

### DETAILED DESCRIPTION OF THE EMBODIMENTS

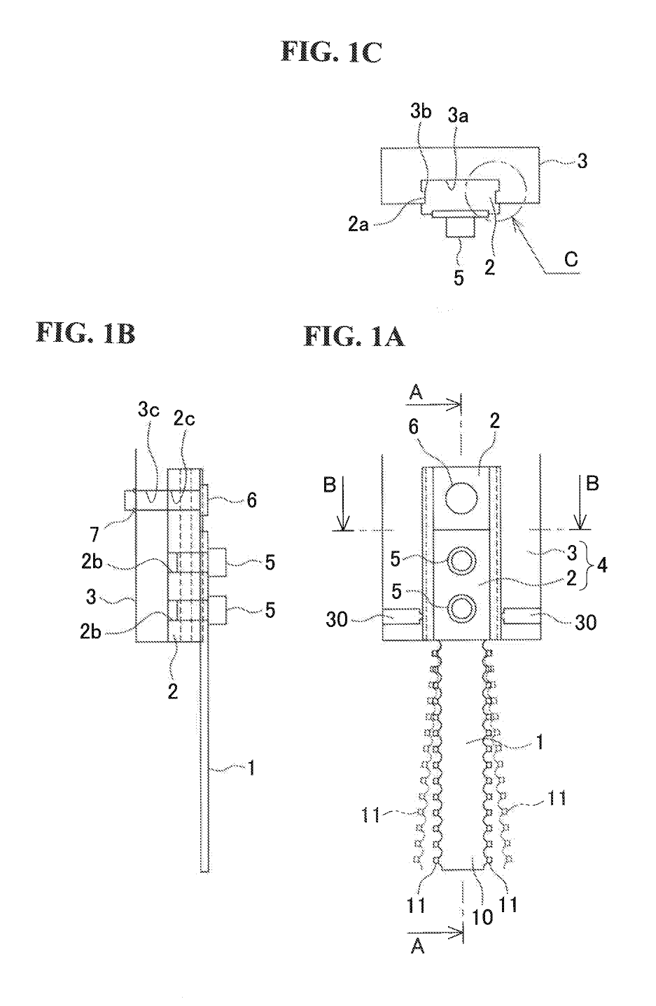

An embodiment of the present invention will be described in detail below with reference to the accompanying drawings. FIGS. 1A to 1C show an example of a grooving tool according to the present invention. FIG. 1A is a front view, FIG. 1B is a vertical section taken along line A-A in FIG. 1A, and FIG. 1C is a sectional view taken along line B-B in FIG. 1A. In a tool holder 4, a block 2 to which a tool is mounted is held by a base 3. FIGS. 1A to 1C show a tool 1 mounted on the tool holder 4. As shown in FIGS. 1A to 1C, the tool 1 is fixed so as to suspend with its upper part being held by the base 3, and performs grooving of a workpiece.

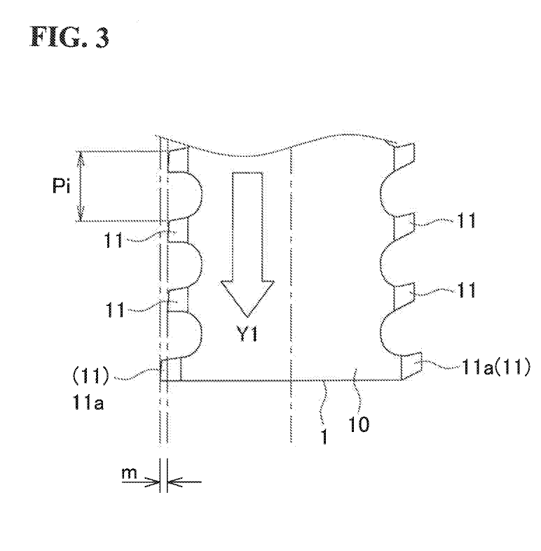

The tool 1 includes a plate 10 made of a rectangular steel sheet, and a cutting blade group provided on both longitudinal sides of the plate 10. The cutting blade group on each longitudinal side of the plate 10 is comprised of a plurality of cutting blade 11 linearly arranged at a constant pitch like a saw FIG. 3 is an enlarged view of the tip end of the tool 1. As shown in FIG. 3, cutting edges of the cutting blades 11 formed on one side of the plate 10 face downward, and cutting edges of the cutting blades 11 formed on the other side of the plate 10 face upward.

As shown in FIG. 3, a cutting blade (tip end blade) 11a formed at the tip end of the tool 1 protrudes slightly beyond the other cutting blades 11 by a protrusion amount m. This cutting blade 11 a is a blade that is used for finish processing described below. As described below, the tool 1 is fixed to the block 2 by using two bolts 5, and the block 2 is pivotally attached to and held by the base 3 by using a pin 6.

The block 2 is a metal block body configured so that the tool 1 is mounted on its front surface and its back surface closely contacts the base 3. A groove 2a that engages with the base 3 is vertically formed in each of the right and left side surfaces of the block 2. The block 2 has a pair of screw holes 2b in the longitudinal direction in order to firmly fix the tool 1. The tool 1 is firmly fixed by bolts 5. A pin insertion hole 2c that is used to attach the block 2 to the base 3 is formed above the screw holes 2b, namely in the upper central part of the block 2.

The base 3 has a rectangular recess 3a that accommodates the block 2. A ridge member 3b that engages with the groove 2a of the block 2 is vertically formed on each of the right and left wall surfaces of the rectangular recess 3a. The block 2 is slid and inserted from below into the rectangular recess 3a so as to be accommodated therein.

A coupling hole 3c corresponding to the pin insertion hole 2c of the block 2 is formed in the upper part in the rectangular recess 3a. The block 2 is pivotally attached to the base 3 by inserting the pin 6 through the holes 2c, 3c from a block 2 side. The tip end of the pin 6 protrudes from the back of the base 3, and a snap ring 7 is mounted on the tip end of the pin 6 in order to prevent the pin 6 from coming off.

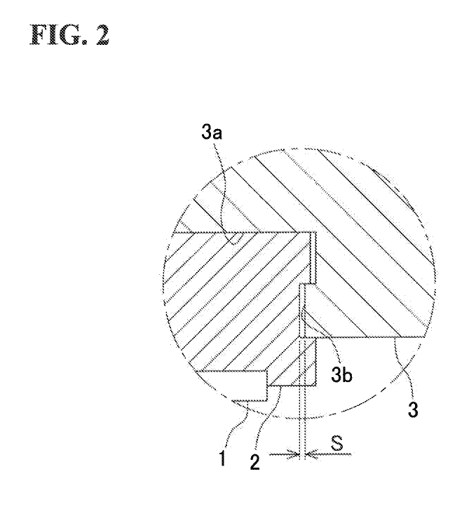

As shown in an enlarged view of a portion C in FIG. 2, the rectangular recess 3a has a width slightly greater than that of the block 2, so that a gap S is formed on both right and left sides of the rectangular recess 3a with the block 2 being accommodated and held therein. With this configuration, the block 2 can be slightly pivoted about the joint by the pin 6, and the tool 1 in a suspended state can slightly swing in the lateral direction. That is, the tool 1 can swing in a plane parallel to the plane in which the cutting blades 11 are formed.

A pair of ball plungers 30 is placed in the lower part of the base 3. Each ball plunger 30 is formed by a ball and a coil spring (not shown). The ball plungers 30 are placed on the right and left sides of the rectangular recess 3a in the lower part of the base 3 so as to face each other. Both of the ball plungers 30 are placed so as to function to press the block 2, and so as to hold the block 2 therebetween in the lateral direction.

As a result, the block 2 is pressed from both right and left sides, and is held in a stable state in the center of the rectangular recess 3a. If the block 2 held by the base 3 is subjected to stress higher than a certain magnitude in the lateral direction, namely in the direction of the cutting blades 11, the block 2 is slightly tilted and swings in the lateral direction, namely the direction of the cutting blades 11, as shown in FIG. 1A.

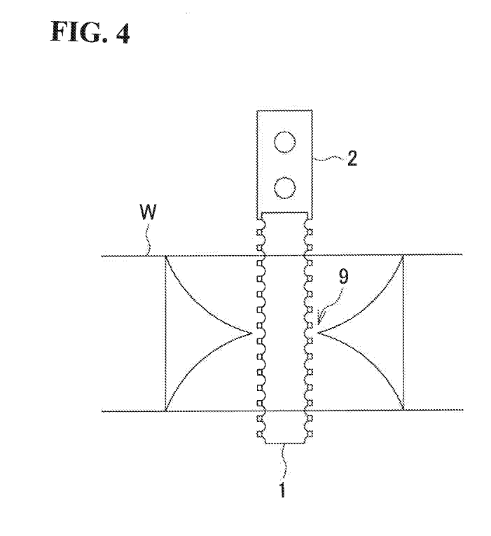

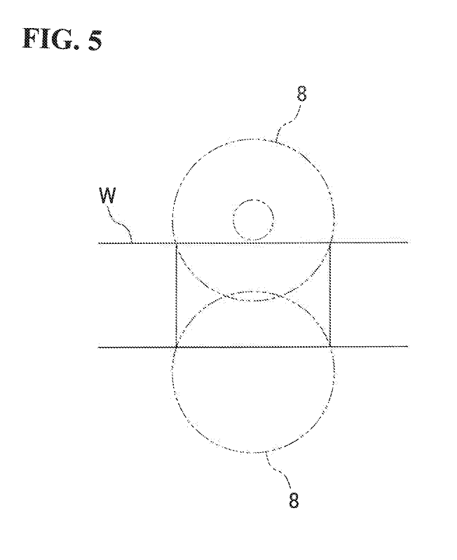

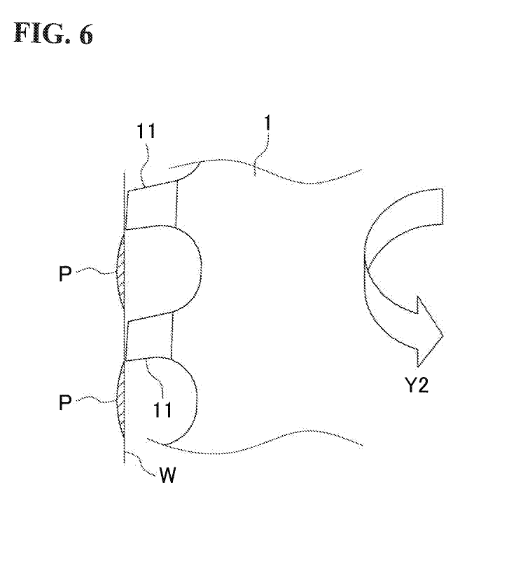

A grooving process using the tool 1 held by the base 3 as described above will be described below with reference to FIGS. 4 to 6. FIG. 4 is a front illustration at the time of approach of a grooving process, FIG. 5 is an illustration of preprocessing of the grooving process in FIG. 4, and FIG. 6 is an enlarged illustration of a processing portion.

As preprocessing of the grooving process, a hole through which the tool 1 is to be inserted is formed in a workpiece W, as shown in FIG. 5. In this example, a metal saw 8 is used to perform rough processing for providing a through portion 9. In this rough processing, the workpiece W is cut from both front and back sides thereof by the metal saw 8. Grooves thus formed are upper and lower semicircular grooves having the shape shown FIG. 4, and the through portion 9 is formed in the center of the grooves.

As shown in FIG. 4, the tool 1 is inserted in this through portion 9 to perform the grooving process. If the tool 1 is placed in a Z-X plane, and a groove is also to be formed in a Z-X plane direction, the tool 1 is caused to make a circular motion on the Z-X plane to perform the grooving process.

FIG. 6 is an illustration of a cutting operation by this circular motion. FIG. 6 shows an example in which the cutting operation is performed by using the downward facing cutting blades 11 and causing the tool 1 to make a downward circular motion as shown by arrow Y2. This processing forms arc-shaped pockets P in the workpiece W by the cutting blades 11. The grooving process is performed by repeating the processing of making this circular motion (pass operation) twice with the tool 1 shifted by a predetermined pitch between the first and second circular motions (2-pass 1-cycle processing) until the workpiece W is cut by a predetermined amount.

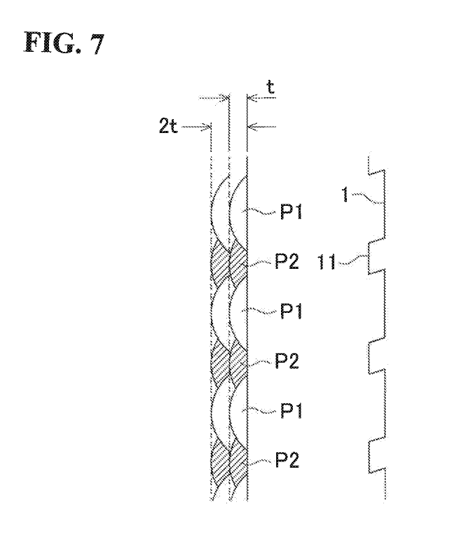

FIG. 7 is an illustration showing a flow of this processing. In FIG. 7, P1 represents a portion that has been cut by the first pass, P2 represents a portion that has been cut by the second pass, and t represents a cutting depth. FIG. 7 shows that pockets P1 having a depth t are formed by a single circular rotation. The number of pockets P1 is the same as that of cutting blades 11 that contact the processing surface of the workpiece W. Then, pockets P2 are formed by making the second circular motion with the tool 1 shifted by a predetermined pitch from the first circular motion.

In this example, the processing is performed by making two circular motions (two pass operations) with the tool 1 shifted by half of a pitch Pi (shown in FIG. 3) of the cutting blades 11 between the first and second circular motions. Thus, in this processing, the workpiece W is cut to a depth 2t. Since the tool 1 has multiple blades, the plurality of pockets P can be formed, and the cutting amount per unit time can be increased by the minimum amount of movement.

The processing of the left side in the grooving process is described above, and the opposite side of the groove is processed by cutting with the upward facing cutting blades 11 formed on the opposite side of the tool 1.

This processing is performed by moving the tool 1 upward. The left side is processed by a downward operation of the circular motion, and then the right side is processed by an upward operation of the continuous circular motion. The right side is processed similarly to the left side. For example, 2-pass 1-cycle processing is performed with the tool 1 shifted by half of the pitch Pi of the cutting blades 11 between the two pass operations.

Then, this 2-pass 1-cycle processing is repeated until a preset cutting amount is reached.

As described above, since the circular motion of the tool 1 is made in the plane in which the cutting blades 11 are formed, a single cutting operation is not continuously performed linearly, and chippings are less likely to accumulate between the cutting blades 11. This can reduce load that is applied to the tool 1, and allows smooth processing to be maintained. Since the cutting operation does not involve any linear motion and is performed by using the circular motion, a smooth processing operation can be achieved, and chippings can be dropped after every processing cycle.

Since the processing is performed with the tool 1 shifted by a predetermined pitch, a grooving process that does not cut only a specific part and thus forms a uniform cut surface can be implemented.

Since the cutting blades 11 are provided on both sides of the plate 10, it is not necessary to change the tool to process the opposite side of the groove, and processing time can be reduced. Moreover, the cutting operation can be performed by both downward and upward movements of the tool 1 that is placed vertically, and both ends of the groove can be processed by reciprocating movement using the circular motions of the tool 1 whereby processing time can be reduced.

The tool 1 is not fixed to the base 3, and when subjected to excessive stress, the tool 1 is tilted and the angle of the tool 1 is changed. Thus, the tool 1 can avoid being subjected to the stress, and damage to the tool 1 can be prevented.

Namely, the tool 1 is not tilted due to the biasing force of the pair of ball plungers 30 unless the tool 1 is subjected to excessive stress. Thus, accurate processing can be implemented.

The series of processes described above are the rough processing in which the plurality of pockets P is present on the processing surface. Accordingly, finish processing is lastly performed after the series of processes are finished. As shown in FIG. 3, the tip end blade 11 a protrudes beyond the other cutting blades 11 of the tool 1 by the amount m, and the finish processing is performed by using this protruding tip end blade 11a. As shown in FIG. 3, this finish processing is not performed by a circular motion but by a linear motion shown by arrow Y1, and is performed by using a single cutting blade.

Since the finish processing is thus performed by the linear motion, chippings do not accumulate between the cutting blades 11, and the cutting operation can be smoothly performed. Since the finish processing can be performed by using the protruding tip end blade 11a, it is not necessary to change the tool to perform the finish processing, and processing efficiency is improved.

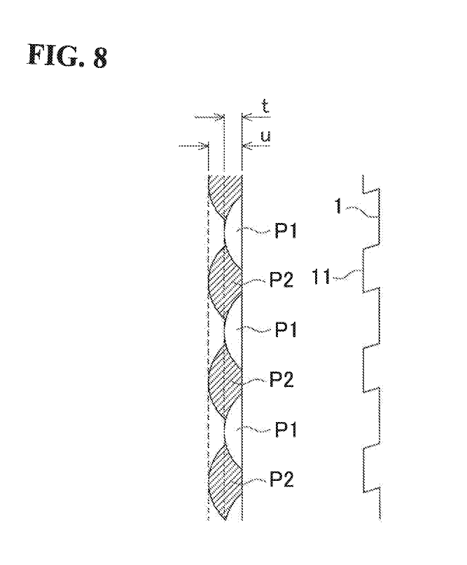

In the above embodiment, the depth in the first pass is the same as that in the second pass that is performed with the tool 1 shifted by a predetermined pitch from the first pass. However, the processing depth may be increased in every pass. Namely, in the processing with the tool 1 shifted by a predetermined pitch from the previous processing, the pockets can be easily formed with a depth greater than that of the pockets formed in the previous processing. Accordingly, the processing depth need not be limited to the same depth, and may be increased in every pass. FIG. 8 shows a flow of the processing in this case. In the processing form shown in FIG. 8, the depth u in the second pass is greater than the depth t in the first pass.

In the above embodiment, the processing is performed by using a circular motion. This processing form can be efficiently implemented in the case where the cutting blades 11 are provided on both sides of the plate 10 and the cutting blades 11 on both sides of the plate 10 face in opposite directions. However, an arc motion rather than the circular motion may be used in the case where the cutting blades on both sides are formed so as to face in the same direction. In this case, the cutting operation is performed in a manner similar to that of the case using the circular motion. However, since this operation does not involve the processing with the cutting blades 11 on the opposite side, the tool 1 is returned by a linear motion. The processing form using the arc motion is satisfactorily applied in the case where the tool includes the cutting blades 11 only on one side of the plate 10.

In the case of using a circular motion or an arc motion, the processing may be performed by an operation including a short-distance linear motion. Making a short-distance linear motion during the processing (while the tool 1 is processing the workpiece 1 in contact with the tool 1) provides the effects described above, and is included in the present invention.

In the case of processing both sides one by one or in the case of processing only one side, the processing may be performed by using a tool having downward-facing cutting blades on both sides or a tool having cutting blades only on one side.

The number of passes per cycle is not limited to two, and may be three or four. The number of passes per cycle can be set according to the shape of the tool 1 or the workpiece W to be used, and the shift amount between the passes need not necessarily be fixed to half of the pitch Pi of the cutting blades 11.

A tool base to which the tool holder 4 is attached is not limited to a machining center main spindle, and the tool holder 4 may be attached to a lathe turret, a special tool base, etc.

What is claimed is:

1. A grooving method, comprising:
cutting a workpiece by causing a tool to make a circular motion or an arc motion, wherein
the tool includes a cutting blade group which is comprised of a plurality of cutting blades arranged linearly and whose cutting direction is a direction in which the plurality of cutting blades is arranged, and the circular motion or the arc motion is made in a plane in which the cutting blades are arranged.

2. The grooving method according to claim 1, wherein
after the cutting operation using the circular motion or the arc motion is performed, the cutting operation using the circular motion or the arc motion is repeated with the tool shifted by a predetermined pitch in the cutting direction.

3. The grooving method according to claim 1, wherein
the tool has the cutting blade group on both right and left sides of a plate that is placed vertically, and the cutting blade groups on both sides of the plate are arranged so as to be parallel to each other and so as to have opposite cutting directions to each other, and
after being cut downward with the downward-facing cutting blade group, the workpiece is cut upward with the upward-facing cutting blade group, and right and left side portions of a groove are cut by one reciprocating movement of the tool using the circular motion.

4. The grooving method according to claim 2, wherein
the tool has the cutting blade group on both right and left sides of a plate that is placed vertically, and the cutting blade groups on both sides of the plate are arranged so as to be parallel to each other and so as to have opposite cutting directions to each other, and
after being cut downward with the downward-facing cutting blade group, the workpiece is cut upward with the upward-facing cutting blade group, and right and left side portions of a groove are cut by one reciprocating movement of the tool using the circular motion.

5. A grooving tool which is mounted on a machine tool including a mechanism that moves along at least two perpendicular axes, and which performs a grooving process on a workpiece, comprising:
a cutting blade group which is comprised of a plurality of cutting blades arranged linearly and whose cutting direction is a direction in which the plurality of cutting blades is arranged, wherein
the cutting blade group is placed on both right and left sides of a plate that is placed vertically, and the cutting blade groups on both sides of the plate are arranged so as to be parallel to each other and so as to have opposite cutting directions to each other.

6. The grooving tool according to claim 5, wherein
of the cutting blade groups placed on both sides of the plate so as to be parallel to each other, the cutting blade located at a tip end is placed so as to protrude beyond the remainder of the cutting blades by a predetermined amount.

7. A grooving tool holding structure, comprising: a tool holder in which a block having attached thereto a grooving tool having a plurality of cutting blades arranged linearly is held by a base, wherein
the grooving tool holding structure holds the tool holder on a tool base of a machine tool including a mechanism that moves along at least two perpendicular axes, and
the block is pivotally attached to and held by the base, and the block held by the base is capable of swinging in a plane parallel to a plane in which the cutting blades are arranged.

8. The grooving tool holding structure according to claim 7, wherein
the base has a limiting unit that limits a swing width of the block, and an elastic biasing unit that biases the block in a direction in which swinging is restrained,
the elastic biasing unit is formed in a pair so as to press from right and left the block that swings in a swing plane, and
the block is biased by the elastic biasing unit and held in a stable state at a prescribed angle, and is tilted within a swing range when subjected to an external force exceeding certain stress.
